(19) United States
(12) Patent Application Publication
(10) Pub. No.: US 2026/0006409 A1
(43) Pub. Date: Jan. 1, 2026

(54) METHOD FOR SENDING/RECEIVING MBS RECEPTION STATE INFORMATION AND APPARATUS

(71) Applicant: Beijing Xiaomi Mobile Software Co., Ltd., Beijing (CN)

(72) Inventor: Yumin WU, Beijing (CN)

(73) Assignee: Beijing Xiaomi Mobile Software Co., Ltd., Beijing (CN)

(21) Appl. No.: 18/879,547

(22) PCT Filed: Jun. 28, 2022
(86) PCT No.: PCT/CN2022/102076

§ 371 Date: Dec. 27, 2024

(51) Int. Cl. H04W 4/06

(52) U.S. Cl. CPC H04W 4/06

(57) ABSTRACT

A method for sending MBS reception status information. The method includes sending MBS reception status information to a network device.

### CROSS-REFERENCE TO RELATED APPLICATION

This application is the U.S. national phase application of International Application No. PCT/CN2022/102076, filed on Jun. 28, 2022, the disclosure of which is incorporated herein by reference in its entirety for all purposes.

### TECHNICAL FIELD

The present disclosure relates to the field of communication technologies, and in particular, to a method for sending/receiving multicast broadcast services (MBS) reception status information and an apparatus therefor.

### BACKGROUND

In related arts, a network device cannot effectively determine a reception status of a terminal device for a multicast broadcast service (MBS). When the network device configures the terminal device to receive the MBS, the terminal device may be receiving other MBSs at the same time, which may cause MBS data scheduled by the network device exceeding a processing capacity of the terminal device, thereby resulting in a packet loss problem of the MBS data.

### SUMMARY

Examples of the present disclosure provide a method for sending/receiving multicast broadcast service (MBS) reception status information and an apparatus therefor. By receiving the MBS reception status information reported by a terminal device, a current MBS reception status of the terminal device can be identified based on the MBS reception status information to solve a packet loss problem of MBS data.

In a first aspect, an example of the present disclosure provides a method for sending MBS reception status information, performed by a terminal device, which includes: sending MBS reception status information to a network device.

In the example of the present disclosure, by receiving the MBS reception status information reported by the terminal device, a current MBS reception status of the terminal device can be identified based on the MBS reception status information. Furthermore, MBS data is scheduled for the terminal device based on the MBS reception status information. During a scheduling process, suitable MBS data can be scheduled for the terminal device since the network device takes the MBS reception status information into consideration, which can prevent the scheduled MBS data from exceeding a maximum receiving capacity of the terminal device, thereby ensuring a correct transmission of the MBS data and reducing a packet loss rate of the MBS data.

In a second aspect, an example of the present disclosure provides a method for receiving MBS reception status information, performed by a network device, which includes: receiving MBS reception status information sent by a terminal device.

In a third aspect, an example of the present disclosure provides a communication apparatus including one or more processors and one or more memories. The one or more memories store a computer program. The one or more processors execute the computer program stored in the one or more memories to enable the communication apparatus to send MBS reception status information to a network device.

### BRIEF DESCRIPTION OF THE DRAWINGS

In order to explain the technical solutions in examples or background of the present disclosure more clearly, the accompanying drawings that need to be used in the examples or the background of the present disclosure will be introduced below.

FIG. 1 is a schematic architectural diagram of a communication system provided in an example of the present disclosure.

FIG. 2 is a schematic flowchart of a method for sending MBS reception status information provided in an example of the present disclosure.

FIG. 3 is a schematic diagram of time domain information for an MBS reception provided in an example of the present disclosure.

FIG. 4 is a schematic flowchart of another method for sending MBS reception status information provided in an example of the present disclosure.

FIG. 5 is a schematic flowchart of a method for receiving MBS reception status information provided in an example of the present disclosure.

FIG. 6 is a schematic flowchart of another method for receiving MBS reception status information provided in an example of the present disclosure.

FIG. 7 is a schematic structural diagram of a communication apparatus provided in an example of the present disclosure.

FIG. 8 is a schematic structural diagram of another communication apparatus provided in an example of the present disclosure.

FIG. 9 is a schematic structural diagram of a chip provided in an example of the present disclosure.

### DETAILED DESCRIPTION OF THE EMBODIMENTS

Embodiments will be described in detail here, and examples of them are illustrated in the drawings. Where the following descriptions involve the drawings, like numerals in different drawings refer to like or similar elements unless otherwise indicated. The implementations described in the following examples do not represent all implementations consistent with the present disclosure. Rather, they are merely examples of apparatuses and methods consistent with some aspects of the present disclosure as detailed in the appended claims.

The terms used in the present disclosure are for the purpose of describing particular examples only, and are not intended to limit the present disclosure. Terms determined by “a” and “the” in their singular forms used in the examples of the present disclosure and the appended claims are also intended to include their plural forms, unless clearly indicated otherwise in the context. It is also to be understood that the term “and/or” as used herein is and includes any and all possible combinations of one or more of the associated listed items.

It is to be understood that, although terms “first,” “second,” “third,” and the like may be adopted in the examples of the present disclosure to describe various information, such information should not be limited to these terms. These terms are only used to distinguish the information of the same type with each other. For example, without departing from the scope of the examples of the present disclosure, first information may be referred as second information; and similarly, second information may also be referred as first information. Depending on the context, the word “if” as used herein may be interpreted as “when,” “upon,” or “in response to determining”. For the purposes of brevity and ease of understanding, the terms “greater than” or “less than,” “higher than” or “lower than” as used here to characterize size relationships. However, those skilled in the art can understand that the term “greater than” also covers the meaning of “greater than or equal to,” the term “less than” also covers the meaning of “less than or equal to,” the term “higher than” covers the meaning of “higher than or equal to,” and the term “lower than” also covers the meaning of “lower than or equal to.”

To facilitate understanding, the terms involved in this present disclosure are first introduced.

A multimedia broadcast multicast service (MBMS) or a multicast broadcast service (MBS) is a technology that transmits data from a data source to multiple target mobile terminals, realizing a sharing of network (including one or more core networks and one or more access networks) resources and improving a utilization of network resources (especially air interface resources).

A network device may schedule MBS data dynamically or semi-persistent. As an example, it dynamically schedules physical resources of physical downlink shared channels (PDSCHs) through physical downlink control channels (PDCCHs) corresponding to a group-radio network temporary identity (G-RNTI) to transmit the MBS data. As another example, it configures periodically allocated PDSCH physical resources to transmit the MBS data, with the resources activated or deactivated through indications of one or more PDCCHs. The one or more PDCCHs may be marked by a semi-persistent group identity. The semi-persistent group identity may be a group-configured scheduling-RNTI (G-CS-RNTI).

For a better understanding of a method for sending MBS reception status information disclosed in examples of the present disclosure, a communication system to which the examples of the present disclosure are applicable is first described below.

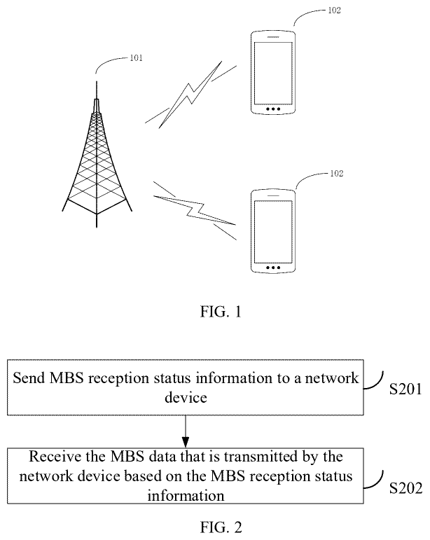

FIG. 1 is a schematic structural diagram of a communication system provided in an example of the present disclosure. The communication system may include, but is not limited to, one network device and one terminal device. The number and form of the devices illustrated in FIG. 1 are used only as an example and do not constitute a limitation on the examples of the present disclosure. In practical applications, it may include two or more network devices and two or more terminal devices. The communication system illustrated in FIG. 1 takes an example that includes one network device 101 and two terminal devices 102.

It is to be noted that the technical solution of the example of the present disclosure may be applied to various communication systems, such as a long term evolution (LTE) system, a fifth generation (5G) mobile communication system, a 5G new radio (NR) system, or another new future mobile communication system. It is also to be noted that a sidelink in the example of the present disclosure may also be called a side link or a direct link.

The network device 101, in the example of the present disclosure is an entity on a network side for transmitting or receiving signals. For example, the network device 101 may be an evolved NodeB (eNB), a transmission reception point (TRP), a next generation NodeB (gNB) in an NR system, a base station in other future mobile communication systems, or an access node in a wireless fidelity (WiFi) system, etc. The example of the present disclosure has no limits for the specific technology and the specific device form of the network device. The network device provided in the example of the present disclosure may be composed of a central unit (CU) and one or more distributed units (DUs). The CU may also be called a control unit. The use of the CU-DU architecture allows for splitting a protocol layer of the network device such as the base station, with part of the functions of the protocol layer placed in the CU for a central control, and some or all of the remaining functions of the protocol layer distributed in the DUs that are controlled centrally by the CU.

The terminal device 102 in the example of the present disclosure is an entity on a user side for receiving or transmitting signals, for example, a mobile phone. The terminal device may also be called a terminal, user equipment (UE), a mobile station (MS), a mobile terminal (MT), etc. The terminal device may be a car equipped with a communication function, a smart car, a mobile phone, a wearable device, a pad, a computer with a wireless transmission and reception function, a virtual reality (VR) terminal device, an augmented reality (AR) terminal device, a wireless terminal device in industrial control, a wireless terminal device in self-driving, a wireless terminal device in a remote medical surgery, a wireless terminal device in a smart grid, a wireless terminal device in transportation safety, a wireless terminal device in a smart city, a wireless terminal device in a smart home, etc. The example of the present disclosure has no limits for the specific technology and the specific device form of the terminal device.

In a sidelink communication, there are 4 sidelink transmission modes. Sidelink transmission mode 1 and sidelink transmission mode 2 are used for a device-to-device (D2D) communication of the terminal device. Sidelink transmission mode 3 and sidelink transmission mode 4 are used for a vehicle-to-everything (V2X) communication. When sidelink transmission mode 3 is adopted, the resource allocation is scheduled by the network device 101. Specifically, the network device 101 may send resource allocation information to the terminal device 102, and then the terminal device 102 allocates resources to another terminal device, so that said another terminal device can transmit information to the network device 101 through the allocated resources. In the V2X communication, a terminal device with better signals or higher reliability may be considered the terminal device 102. A first terminal device mentioned in the example of the present disclosure may refer to the terminal device 102, and a second terminal device may refer to said another terminal device.

It is to be understood that the communication system described in the example of the present disclosure is intended to illustrate the technical solutions of the examples of the present disclosure more clearly, but do not constitute any limitation to the technical solutions provided in the examples of the present disclosure. Those of ordinary skill in the art will know that the technical solutions provided in the examples of the present disclosure are also applicable to similar technical problem which occurs with the system architecture evolving and new business scenarios emerging.

It is to be noted that the method of reporting MBS reception status information provided in any example of the present disclosure may be performed independently, or may be performed in combination with one or more possible implementation methods in other examples, or may be performed in combination with any technical solution in related arts.

The methods for sending MBS reception status information and apparatuses therefor provided in the present disclosure are described in detail below in conjunction with the accompanying drawings.

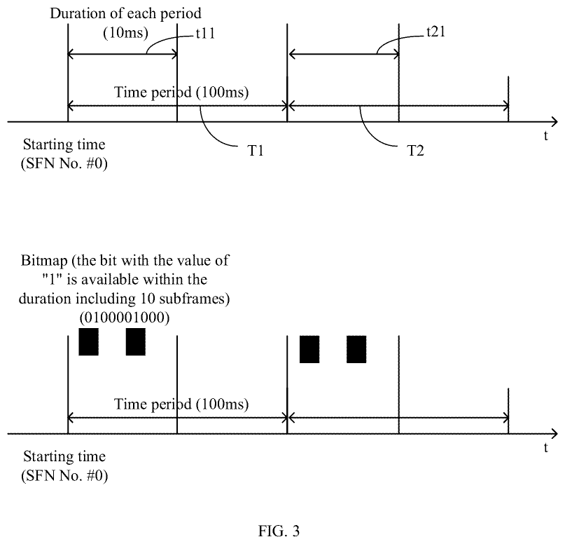

Referring to FIG. 2, it is a schematic flowchart of a method for sending MBS reception status information provided in an example of the present disclosure. The method for sending MBS reception status information is performed by a terminal device. As illustrated in FIG. 2, the method may include, but is not limited to, the following step.

At S201, MBS reception status information is sent to a network device.

It is to be noted that the MBS reception status information may reflect a current MBS reception status of the terminal device. The terminal device may report the MBS reception status information to the network device, so that the network device can identify the current MBS reception status of the terminal device.

In some implementations, the terminal device may send the MBS reception status information to the network device via uplink control information (UCI). Alternatively, or additionally, the MBS reception status information may occupy one or more information fields of the UCI. The occupied information field may be an idle information field, or may multiplex a non-idle information field. The one or more information fields occupied by the MBS reception status information may be determined based on a protocol agreement or a network indication. Alternatively, or additionally, the number of information fields or the number of bits occupied by the MBS reception status information in the UCI may be determined based on a protocol or a network indication.

Alternatively, or additionally, the MBS reception status information includes at least one of the following:
frequency information for an MBS reception;
time domain information for the MBS reception;
configuration information for the MBS reception;
a frequency configuration chosen by the terminal device;
a time domain configuration chosen by the terminal device;
a configuration chosen by the terminal device;
a type of the MBS reception status information;
a wireless technology type of the MBS reception; or
a service type corresponding to the MBS reception.

Alternatively, or additionally, the frequency information for the MBS reception or the frequency configuration chosen by the terminal device includes at least one of the following: frequency point information for the MBS reception, bandwidth information for the MBS reception, subcarrier spacing information for the MBS reception, bandwidth part (BWP) information for the MBS reception, or a resource indication for the MBS reception.

The frequency point information for the MBS reception includes at least one of the following: a starting frequency point of the MBS reception, an ending frequency point of the MBS reception, or a central frequency point of the MBS reception.

The bandwidth information for the MBS reception includes at least one of the following: a frequency band width for the MBS reception, or a number of physical resource blocks for the MBS reception. The bandwidth width of the MBS reception may include a maximum frequency bandwidth of the MBS reception and/or a minimum frequency bandwidth of the MBS reception. The number of physical resource blocks for the MBS reception may include a maximum number of physical resource blocks for the MBS reception and/or a minimum number of physical resource blocks for the MBS reception.

The subcarrier spacing information for the MBS reception may include at least one of the following frequency spacings: 15 kHz, 30 kHz, 60 kHz, 120 kHz, or 240 kHz.

Alternatively, or additionally, the time domain information for the MBS reception or the time domain configuration chosen by the terminal device includes at least one of the following: starting time information for the MBS reception, a time period of the MBS reception, a duration of a transmission period within the time period, time domain positions in time in the transmission period, or a number of received symbols.

The starting time information for the MBS reception may include at least one of the following: a start system frame number (SFN), a start subframe number, a start slot number, and a start symbol number. As illustrated in FIG. 3, the starting time may be SFN #0.

As illustrated in FIG. 3, T1 and T2 represent two adjacent time periods being 100 milliseconds (ms) for the MBS reception. Each time period includes one transmission period. For example, time period T1 includes a transmission period t11, and time period T2 includes a transmission period t21. The duration of the transmission period is 10 milliseconds.

Each transmission period includes a time position in time domain. For example, the time position in time domain may be located at a front position within the transmission period. As an example, the transmission period is 10 ms, and the time position in time domain within the transmission period may be located at the first 5 ms. Alternatively, or additionally, the time position in time domain may be indicated by a bitmap. For example, the bitmap includes a plurality of candidate time domain positions, and it may be determined based on a value of each candidate time domain position on the bitmap whether the candidate time domain position is the time position in time domain within the transmission period. As an example, it may be determined that the candidate time domain position is the time position in time domain within the transmission period if the value of the candidate time domain position is “1” and that the candidate time domain position is not the time position in time domain within the transmission period if the value of the candidate time domain position is “0”. As illustrated in FIG. 3, the bitmap includes 10 subframes, and the values of the bitmap are 0100001000, which can determine that subframe #1 and subframe #6 are the time positions in time domain within the transmission period.

The number of received symbols for the MBS reception is a number of orthogonal frequency division multiplexing (OFDM) symbols to be occupied by the MBS reception on a downlink channel. For example, 7 OFDM symbols are occupied for the MBS reception on each PDSCH.

The BWP information for the MBS reception may be a BWP identifier. For example, the BWP identifier may indicate that the BWP for the MBS reception is an initial BWP. Alternatively, the BWP identifier may indicate that the BWP for the MBS reception is a configured BWP.

The resource indication for the MBS reception, for example, may be a resource indicator value (RIV). The number and positions of physical blocks used for the MBS reception may be indicated by the RIV.

Alternatively, or additionally, the configuration information for the MBS reception or the configuration chosen by the terminal device includes at least one of the following: a modulation and demodulation mode used by the terminal device, a maximum number of multiple-input multiple-output (MIMO) antenna layers supported by the terminal device, a number of antennas used for the MBS reception, a number of antenna ports used for the MBS reception, one or more antenna port numbers used for the MBS reception, a number of hybrid automatic repeat request (HARQ) processes used, one or more HARQ process numbers used, a repetition transmission scheme of a data channel for an MBS transmission, a cache size used for the terminal device, or a processing capability scaling factor of the terminal device. The modulation and demodulation mode for the MBS reception may adopt one of the modulation and demodulation modes supported by the terminal device. For example, it may adopt a maximum modulation and demodulation mode such as 256 quadrature amplitude modulation (QAM).

The maximum number of downlink MIMO antenna layers supported by the terminal device may be L layers. In the example of the present disclosure, the maximum number of MIMO antenna layers may be included in the MBS reception status information of the terminal device. For example, the maximum number of MIMO antenna layers may be 2 layers.

The number of antennas deployed by the terminal device may be N, with N being a positive integer greater than 0. During the MBS reception, the terminal device may use a part of the N antennas to perform the MBS reception, or may use all the N antennas to perform the MBS reception. In the example of the present disclosure, the terminal device may report the number of antennas used for the MBS reception in the MBS reception status information.

The number of antenna ports deployed by the terminal device may be M, with M is a positive integer greater than 0. During the MBS reception, the terminal device may use a part of the M antenna ports to perform the MBS reception, or may use all the M antenna ports to perform the MBS reception. In the example of the present disclosure, the terminal device may report the number of antenna ports used for the MBS reception in the MBS reception status information.

It is to be noted that one or more antennas corresponding to the number of antenna layers used for the MBS reception, the number of antennas used, the number of antenna ports used and the antenna port numbers used include one or more receiving antennas and/or one or more transmitting antennas.

The terminal device may configure information for the MBS reception such as a number of repetitions, frequency and/or timing of repetitions. By means of such information, the repetition scheme of a data channel for the MBS transmission may be indicated.

The terminal device may be equipped with a data link layer (that is Layer 2, L2) cache. The MBS data may be cached through the L2 cache to avoid data loss or congestion due to a failure to process the MBS data timely. In the example of the present disclosure, the terminal device may report the size of the L2 cache in the MBS reception status information.

Alternatively, or additionally, the processing capability scaling factor of the terminal device may be a scaling factor of a baseband processing capability. For example, the terminal device may scale a buffering requirement of the terminal device according to the processing capability scaling factor.

It is to be noted that for the frequency configuration chosen by the terminal device, it may be considered that the terminal device prefers to frequency information configured by the network device for its MBS reception, and for the time domain configuration chosen by the terminal device, it may be considered that the terminal device prefers to time domain information configured by the network device for its MBS data scheduling,

Alternatively, or additionally, the type of the MBS reception status information includes any one of the following: a reception status of the MBS data being received by the terminal device, or a reception status of the MBS data to be received by the terminal device. The MBS data to be received by the terminal device may be the MBS data that the terminal device is interested in. For example, the terminal device may send a request to the network device, and the request carries the MBS data that the terminal device is interested in.

Alternatively, or additionally, the wireless technology type for the MBS reception is any one of the following types: an NR system, an LTE system, or a universal mobile telecommunications system (UMTS). That is, the MBS reception is performed under the wireless technology type supported by the terminal device. As an example, the MBS reception may be performed on the NR system if the terminal device supports the NR system. As another example, if the terminal device supports the NR system, the LTE system and the UMTS, the MBS reception may be performed on one specified system of them.

The service type corresponding to the MBS reception includes at least one of the following types: a broadcast MBS and a multicast MBS.

Alternatively, or additionally, the terminal device may receive one or more MBSs at the same time, and accordingly, the terminal device may report the MBS reception status information of the one or more MBSs received at the same time. For example, the terminal device may report one of a plurality of pieces of MBS reception status information at the same time. Alternatively, the terminal device may report an information combination of the plurality of pieces of MBS reception status information at the same time.

The method for sending MBS reception status information provided in the example of the present disclosure may further include the following step.

At S202, the MBS data that is transmitted by the network device based on the MBS reception status information is received.

After the terminal device sends the MBS reception status information to the network device, the network device may schedule the MBS data for the terminal device based on the MBS reception status information. The terminal device may receive the MBS data transmitted by the network device. In the example of the present disclosure, since the MBS reception status information is considered when the network device schedules the MBS data for the terminal device, the network device may identify the current MBS reception status of the terminal device, which can prevent the scheduled MBS data from exceeding the maximum receiving capacity of the terminal device during the scheduling process, thereby ensuring the correct transmission of the MBS data and reducing the packet loss rate of the MBS data.

In the example of the present disclosure, by reporting the MBS reception status information to the network device, the network device can identify the current MBS reception status of the terminal device based on the MBS reception status information, which can prevent the scheduled MBS data from exceeding the maximum receiving capacity of the terminal device during the scheduling process, thereby ensuring the correct transmission of the MBS data and reducing the packet loss rate of the MBS data.

FIG. 4 is a schematic flowchart of a method for sending MBS reception status information provided in an example of the present disclosure. The method for sending MBS reception status information is performed by a terminal device. As illustrated in FIG. 4, the method may include, but is not limited to, the following steps.

At S401, indication information sent by a network device is received, where the indication information indicates whether MBS reception status information is allowed to be reported.

Alternatively, or additionally, the indication information sent by the network device via broadcast signaling or dedicated signaling is received.

As an example, the broadcast signaling may be a system information block (SIB), and thus the terminal device may receive from the network device the indication information that carries permission to report the MBS reception status information.

As another example, the dedicated signaling may be a radio resource control (RRC) Reconfiguration message, and thus the terminal device may receive from the network device the indication information that carries permission to report the MBS reception status information.

Alternatively, or additionally, the indication information may occupy one or more idle bits or information fields in the SIB or the RRC Reconfiguration message, or the indication information may multiplex one or more non-idle bits or information fields in the SIB or the RRC Reconfiguration message. The bits or information fields occupied by the indication information may be determined based on a protocol agreement or a network indication. Alternatively, or additionally, the number of bits or the number of information fields in the SIB or the RRC Reconfiguration message occupied by the indication information may be determined based on a protocol or a network indication.

In the example of the present disclosure, the indication information includes at least one of the following:
whether the MBS reception status information is allowed to be reported;
whether frequency information for an MBS reception is allowed to be reported;
whether time domain information for the MBS reception is allowed to be reported;
whether a frequency configuration chosen by the terminal device is allowed to be reported; or
whether a time domain configuration chosen by the terminal device is allowed to be reported.

At S402, the MBS reception status information is reported to the network device according to the indication information.

In the example of the present disclosure, according to the indication information after it is obtained, the terminal device may determine whether the MBS reception status information is allowed to be reported, and determine the specific contents of the MBS reception status information allowed to be reported. As an example, the indication information may indicate that the terminal device is allowed to report the MBS reception status information, and is also allowed to report one or more of the frequency information for the MBS reception and the time domain information for the MBS reception, but is not allowed to report one or more of the frequency configuration chosen by the terminal device and the time domain configuration chosen by the terminal device. As another example, the indication information may indicate that the terminal device is allowed to report the MBS reception status information, and is also allowed to report the frequency information for the MBS reception, the time domain information for the MBS reception, the frequency configuration chosen by the terminal device and the time domain configuration chosen by the terminal device.

The detailed introduction to the MBS reception status information may refer to the relevant contents in the above example, which is not repeated here.

Alternatively, or additionally, the frequency information for the MBS reception in the MBS reception status information belongs to a same band combination. For example, the frequency information for the MBS reception reported by the terminal device includes frequency f1 and frequency f2. In the example of the present disclosure, f1 and f2 may belong to the same band combination.

Alternatively, or additionally, the frequency information for the MBS reception and one or more serving frequency points currently configured for the terminal device belong to the same band combination. For example, the frequency information for the MBS reception reported by the terminal device includes frequency f1 and frequency f2. The serving frequency points of the terminal device in the current connection state are at frequency f3. In the example of the present disclosure, f1, f2, and f3 may belong to the same band combination.

Alternatively, or additionally, the frequency information for the MBS reception in the MBS reception state information does not belong to at least one of the following frequency points:
one or more serving frequency points currently configured for the terminal device;
one or more adjacent frequency points indicated in system information currently received by the terminal device; or
one or more frequency points of a network to which the terminal device is currently registered.

In the example of the present disclosure, the frequency information for the MBS reception reported by the terminal device may not belong to one or more of the above frequency points. As an example, the frequency information for the MBS reception does not belong to the serving frequency points currently configured for the terminal device, or does not belong to the adjacent frequency points indicated by the system information currently received by the terminal device, or does not belong to the frequency points of the network to which the terminal device is currently registered.

As another example, the frequency information for the MBS reception neither belongs to the serving frequency points currently configured for the terminal device nor belongs to the adjacent frequency points indicated by the system information currently received by the terminal device; or, the frequency information for the MBS reception neither belongs to the serving frequency points currently configured for the terminal device nor belongs to the frequency points of the network to which the terminal device is currently registered; or, the frequency information for the MBS reception neither belongs to the adjacent frequency points indicated by the system information currently received by the terminal device nor belongs to the frequency points of the network to which the terminal device is currently registered.

As another example, the frequency information for the MBS reception belongs to none of the serving frequency points currently configured for the terminal device, the adjacent frequency points indicated by the system information currently received by the terminal device and the frequency points of the network to which the terminal device is currently registered.

It is to be noted that the frequency information for the MBS reception does not belong to the frequency points of the network to which the terminal device is currently registered. However, a public land mobile network (PLMN) may be included, to which the frequency information for the MBS reception reported by the terminal device belongs and from which the PLMN where the terminal device is currently registered is different.

As a possible implementation, the terminal device may send a first indication to the network device. The first indication indicates frequency information that is applicable to the time domain information for the MBS reception and/or the time domain configuration chosen by the terminal device. For example, the terminal device may indicate frequency point f1 that is applicable to the time domain information for the MBS reception, and/or indicate frequency point f2 that is applicable to the time domain configuration chosen by the terminal device. Alternatively, or additionally, through the first indication, the terminal device indicates to the network device the frequency information applicable to the time domain information for the MBS reception and the time domain configuration chosen by the terminal device respectively. That is, the terminal device may carry a correspondence between the time domain information for the MBS reception and the frequency f1 through one first indication, and carry a correspondence between the time domain configuration chosen by the terminal device and the frequency f2 through another first indication. Alternatively, or additionally, through one first indication, the terminal device may jointly indicate the correspondence between the time domain information for the MBS reception and the frequency f1 and the correspondence between the time domain configuration chosen by the terminal device and the frequency f2.

Alternatively, or additionally, the terminal device may carry f1 and/or f2 in a specific indication field of the first indication. When obtaining f1 and/or f2 from the specific indication field, the network device may learn the correspondence between the time domain information for the MBS reception and the frequency f1 and the correspondence between the time domain configuration chosen by the terminal device and the frequency f2 that are carried.

Alternatively, or additionally, the frequency information that is applicable to the time domain information for the MBS reception and/or the time domain configuration chosen by the terminal device may be identical or different.

As another possible implementation, the terminal device may also send a second indication to the network device. The second indication indicates one or more channel types that are applicable to the time domain information for the MBS reception. Alternatively, or additionally, the terminal device may carry indication information of the one or more channel types that are applicable to the time domain information for the MBS reception in the second indication. Alternatively, or additionally, the terminal device may send a bitmap through the second indication. The bitmap indicates the one or more channel types that are applicable to the time domain information for the MBS reception. It is to be noted that bits at different positions of the bitmap correspond to different channel types. The one or more channel types that are applicable to the time domain information for the MBS reception may be determined based on the values of the bitmap. For example, a bit with a value of “1” may indicate that the channel type corresponding to the bit is the channel type applicable to the time domain information for the MBS reception, and a bit with a value of “0” may indicate that the channel type corresponding to the bit is not the channel type applicable to the time domain information for the MBS reception.

It is to be noted that the one or more channel types that are applicable to the time domain information for the MBS reception include at least one of the following types:
a physical control channel for sending broadcast control signaling;
a physical data channel for sending broadcast control signaling;
a physical control channel for transmitting broadcast data; or
a physical data channel for transmitting broadcast data.

As an example, the broadcast control signaling may include a multicast control channel radio network temporary identifier (MCCH-RNTI). In this case, the one or more information type that are applicable to the time domain information for the MBS reception may be one or more PDCCHs and/or one or more PDSCHs corresponding to the broadcast control signaling.

As another example, the broadcast data may include a G-RNTI of a multicast service. The G-RNTI indicates an identifier of the multicast service at the physical layer. In this case, the one or more information types that are applicable to the time domain information for the MBS reception may be one or more PDCCHs and/or one or more PDSCHs corresponding to the broadcast data.

The method for reporting MBS reception status information provided in the example of the present disclosure may further include the following step.

At S403, the MBS data that is transmitted by the network device based on the MBS reception status information is received.

After the terminal device sends the MBS reception status information to the network device, the network device may schedule the MBS data for the terminal device based on the MBS reception status information. The terminal device may receive the MBS data transmitted by the network device. In the example of the present disclosure, since the MBS reception status information is considered when the network device schedules the MBS data for the terminal device, the network device may identify a current MBS reception status of the terminal device, which can prevent the scheduled MBS data from exceeding the maximum receiving capacity of the terminal device during the scheduling process, thereby ensuring the correct transmission of the MBS data and reducing the packet loss rate of the MBS data.

In the example of the present disclosure, by reporting the MBS reception status information to the network device, the network device can identify the current MBS reception status of the terminal device based on the MBS reception status information, which can prevent the scheduled MBS data from exceeding the maximum receiving capacity of the terminal device during the scheduling process, thereby ensuring the correct transmission of the MBS data and reducing the packet loss rate of the MBS data.

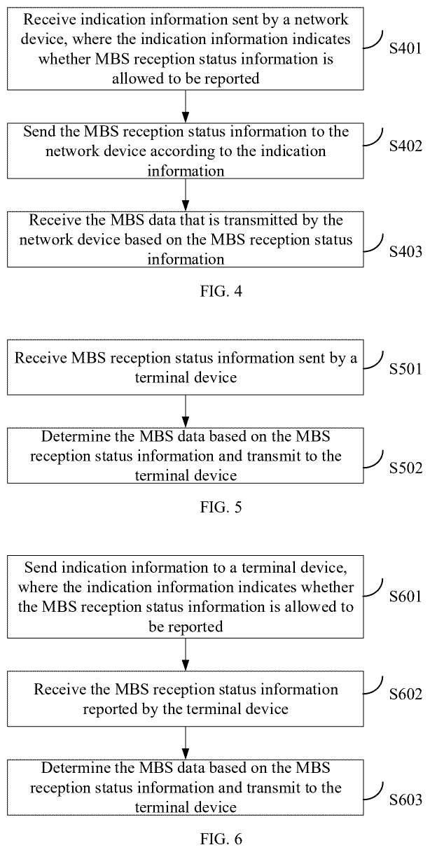

Referring to FIG. 5, it is a schematic flowchart of a method for receiving MBS reception status information provided in an example of the present disclosure. The method for receiving MBS reception status information is performed by a network device. As illustrated in FIG. 5, the method may include, but is not limited to, the following step.

At S501, MBS reception status information sent by a terminal device is received.

It is to be noted that the MBS reception status information may reflect a current MBS reception status of the terminal device. The network device may receive the MBS reception status information sent by the terminal device, and then identify the current MBS reception status of the terminal device, so as to reasonably schedule MBS data for the terminal device.

In some implementations, the network device may receive the MBS reception status information sent by the terminal device via UCI. Alternatively, or additionally, the MBS reception status information may occupy one or more information fields of the UCI. The occupied information field may be an idle information field, or may multiplex a non-idle information field. The one or more information fields occupied by the MBS reception status information may be determined based on a protocol agreement or a network indication. Alternatively, or additionally, the number of information fields or the number of bits occupied by the MBS reception status information in the UCI may be determined based on a protocol or a network indication.

Alternatively, or additionally, the MBS reception status information includes at least one of the following:
frequency information for an MBS reception;
time domain information for the MBS reception;
configuration information for the MBS reception;
a frequency configuration chosen by the terminal device;
a time domain configuration chosen by the terminal device;
a configuration chosen by the terminal device;
a type of the MBS reception status information;
a wireless technology type of the MBS reception; or
a service type corresponding to the MBS reception.

The detailed introduction to the MBS reception status information may refer to the relevant contents in the above examples, which is not repeated here.

The method for reporting MBS reception status information provided in the example of the present disclosure may further include the following step.

At S502, the MBS data is determined based on the MBS reception status information and is transmitted to the terminal device.

After receiving the MBS reception status information sent by the terminal device, the network device may determine the current MBS reception status of the terminal device. In order to prevent the MBS data scheduled for the terminal device from exceeding the maximum receiving capacity of the terminal device, in the example of the present disclosure, the network device may schedule suitable MBS data for the terminal device based on the MBS reception status information. For example, based on the MBS reception status information, the network device may configure the serving frequency points of the terminal device and the frequency points for the MBS reception being in the same band combination; or, the network device may stagger unicast sending events of the terminal device with the time for the MBS reception; or, the network device may schedule reception time of other services of the terminal device. By scheduling the reception time of other services that overlap with the time for the MBS reception, it can ensure that the MBS reception is within the maximum receiving capability of the terminal device.

In the example of the present disclosure, by receiving the MBS reception status information reported by the terminal device, the current MBS reception status of the terminal device can be identified based on the MBS reception status information. Furthermore, the MBS data is scheduled for the terminal device based on the MBS reception status information. During a scheduling process, suitable MBS data can be scheduled for the terminal device since the network device takes the MBS reception status information into consideration, which can prevent the scheduled MBS data from exceeding the maximum receiving capacity of the terminal device, thereby ensuring the correct transmission of the MBS data and reducing the packet loss rate of the MBS data.

Referring to FIG. 6, it is a schematic flowchart of a method for receiving MBS reception status information provided in an example of the present disclosure. The method for receiving MBS reception status information is performed by a network device. As illustrated in FIG. 6, the method may include, but is not limited to, the following steps.

At S601, indication information is sent to a terminal device, where the indication information indicates whether the MBS reception status information is allowed to be reported.

Alternatively, or additionally, the network device may send the indication information to the terminal device via broadcast signaling or dedicated signaling. As an example, the broadcast signaling may be an SIB, and thus, the terminal device may receive the indication information from the network device that carries permission to report the MBS reception status information.

The detailed introduction on sending the indication information to the terminal device via the broadcast signaling or the dedicated signaling may refer to the relevant contents in the above examples, which is not be repeated here.

In the example of the present disclosure, the indication information includes at least one of the following:
whether the MBS reception status information is allowed to be reported;
whether frequency information for an MBS reception is allowed to be reported;
whether time domain information for the MBS reception is allowed to be reported;
whether a frequency configuration chosen by the terminal device is allowed to be reported; or
whether a time domain configuration chosen by the terminal device is allowed to be reported.

At S602, the MBS reception status information reported by the terminal device is received.

The detailed introduction to the MBS reception status information may refer to the relevant contents in the above examples, which is not repeated here.

Alternatively, or additionally, the network device receives a first indication sent by the terminal device. The first indication indicates frequency information that is applicable to the time domain information for the MBS reception and/or the time domain configuration chosen by the terminal device.

Alternatively, or additionally, the network device receives a second indication sent by the terminal device. The second indication indicate one or more channel types that are applicable to the time domain information for the MBS reception. The introduction to the used channel types may refer to the relevant contents in the above examples, which is not be repeated here.

The method for reporting MBS reception status information provided in the example of the present disclosure may further include the following step.

At S603, the MBS data is determined based on the MBS reception status information and is transmitted to the terminal device.

After receiving the MBS reception status information sent by the terminal device, the network device may determine a current MBS reception status of the terminal device. In order to prevent the MBS data scheduled for the terminal device from exceeding the maximum receiving capacity of the terminal device, in the example of the present disclosure, the network device may schedule suitable MBS data for the terminal device based on the MBS reception status information. For example, based on the MBS reception status information, the network device may configure the serving frequency points of the terminal device and the frequency points for the MBS reception being in the same band combination; or, the network device may stagger unicast sending events of the terminal device with the time for the MBS reception; or, the network device may schedule reception time of other services of the terminal device. Scheduling the reception time of other services that overlap with the time for the MBS reception can ensure that the MBS reception is within the maximum receiving capability of the terminal device.

In the example of the present disclosure, by receiving the MBS reception status information reported by the terminal device, the current MBS reception status of the terminal device can be identified based on the MBS reception status information. Furthermore, the MBS data is scheduled for the terminal device based on the MBS reception status information. During a scheduling process, suitable MBS data can be scheduled for the terminal device since the network device takes the MBS reception status information into consideration, which can prevent the scheduled MBS data from exceeding the maximum receiving capacity of the terminal device, thereby ensuring the correct transmission of the MBS data and reducing the packet loss rate of the MBS data.

In the above examples provided in the present disclosure, the methods provided in the examples of the present disclosure are introduced separately from the perspectives of the network device and the terminal device. In order to realize the various functions in the methods provided in the above examples of the present disclosure, the network device and the first terminal device may include hardware structures and software modules, and implement the above various functions in the form of the hardware structures, the software modules, or a combination of the hardware structures and the software modules. A certain function among the above various functions may be implemented in the form of a hardware structure, a software module, or a combination of a hardware structure and a software module.

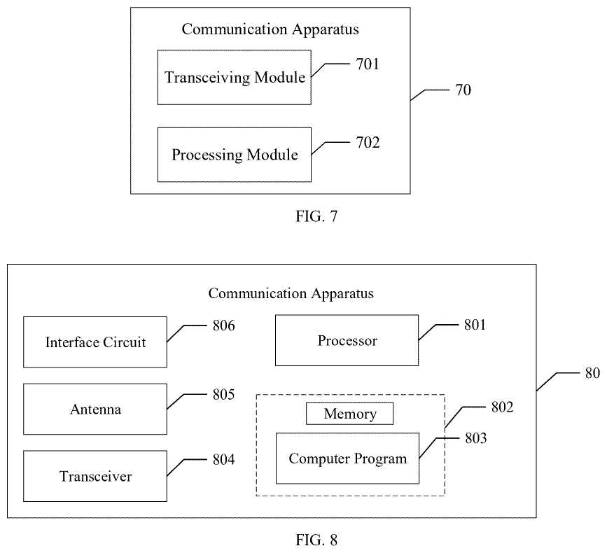

Referring to FIG. 7, it is a schematic structural diagram of a communication apparatus 70 provided in an example of the present disclosure. The communication apparatus 70 illustrated in FIG. 7 may include a transceiving module 701 and a processing module 702. The transceiving module 701 may include a transmitting module and/or a receiving module. The transmitting module is configured to implement a transmission function, the receiving module is configured to implement a reception function, and the transceiving module 701 may implement the transmission function and/or the reception function.

The communication apparatus 70 may be a terminal device, or a device in the terminal device, or a device that may be used in conjunction with the terminal device. Alternatively, the communication apparatus 70 may be a network device, or a device in the network device, or a device that is used in conjunction with the network device.

The communication apparatus 70 is the terminal device:
the transceiving module 701 is configured to send MBS reception status information to a network device.

Alternatively, or additionally, the transceiving module 701 is further configured to receive MBS data that is transmitted by the network device based on the MBS reception status information.

Alternatively, or additionally, the transceiving module 701 is further configured to receive indication information sent by the network device. The indication information indicates whether the MBS reception status information is allowed to be reported.

Alternatively, or additionally, the transceiving module 701 is further configured to receive the indication information sent by the network device via broadcast signaling or dedicated signaling.

Alternatively, or additionally, the indication information includes at least one of the following:
whether the MBS reception status information is allowed to be reported;
whether frequency information for an MBS reception is allowed to be reported;
whether time domain information for the MBS reception is allowed to be reported;
whether a frequency configuration chosen by the terminal device is allowed to be reported; or
whether a time domain configuration chosen by the terminal device is allowed to be reported.

Alternatively, or additionally, the MBS reception status information includes at least one of the following:
frequency information for the MBS reception;
time domain information for the MBS reception;
configuration information for the MBS reception;
a frequency configuration chosen by the terminal device;
a time domain configuration chosen by the terminal device;
a configuration chosen by the terminal device;
a type of the MBS reception status information;
a wireless technology type of the MBS reception; or
a service type corresponding to the MBS reception.

Alternatively, or additionally, the type of the MBS reception status information includes any one of the following:
a reception status for MBS data being received by the terminal device; or
a reception status for MBS data to be received by the terminal device.

Alternatively, or additionally, the frequency information for the MBS reception or the frequency configuration chosen by the terminal device includes at least one of the following: frequency point information for the MBS reception, bandwidth information for the MBS reception, subcarrier spacing information for the MBS reception, BWP information for the MBS reception, or a resource indication for the MBS reception.

Alternatively, or additionally, the frequency point information for the MBS reception includes at least one of the following: a starting frequency point of the MBS reception, an ending frequency point of the MBS reception, or a central frequency point of the MBS reception.

The bandwidth information for the MBS reception includes at least one of the following: a frequency band width for the MBS reception, or a number of physical resource blocks for the MBS reception.

Alternatively, or additionally, the time domain information for the MBS reception or the time domain configuration chosen by the terminal device includes at least one of the following:
starting time information for the MBS reception, a time period of the MBS reception, a duration of a transmission period within the time period, time domain positions in time in the transmission period, or a number of received symbols.

Alternatively, or additionally, the configuration information for the MBS reception or the configuration chosen by the terminal device includes at least one of the following:
a modulation and demodulation mode used by the terminal device, a maximum number of MIMO antenna layers supported by the terminal device, a number of antennas used for the MBS reception, a number of antenna ports used for the MBS reception, one or more antenna port numbers used for the MBS reception, a number of HARQ processes used, one or more HARQ process numbers used, a repetition transmission scheme of a data channel for an MBS transmission, a cache size used for the terminal device, or a processing capability scaling factor of the terminal device.

Alternatively, or additionally, one or more antennas corresponding to the number of antenna layers, the number of antennas used, the number of antenna ports used and the one or more antenna port numbers used include one or more receiving antennas and/or one or more transmitting antennas.

Alternatively, or additionally, the frequency information for the MBS reception belongs to a same band combination; and/or,
the frequency information for the MBS reception and one or more serving frequency points currently configured for the terminal device belong to the same band combination.

Alternatively, or additionally, the frequency information for the MBS reception does not belong to at least one of the following frequency points:
one or more serving frequency points currently configured for the terminal device;
one or more adjacent frequency points indicated in system information currently received by the terminal device; or
one or more frequency points of a network to which the terminal device is currently registered.

Alternatively, or additionally, the transceiving module 701 is further configured to indicate frequency information that is applicable to the time domain information for the MBS reception, and/or, to indicate frequency information that is applicable to the time domain configuration chosen by the terminal device.

Alternatively, or additionally, the transceiving module 701 is further configured to indicate one or more channel types that are applicable to the time domain information for the MBS reception. The one or more channel types include at least one of the following:
a physical control channel for sending broadcast control signaling;
a physical data channel for sending broadcast control signaling;
a physical control channel for transmitting broadcast data; or
a physical data channel for transmitting broadcast data.

The communication apparatus 70 is a network device:
the transceiving module 701 is configured to receive MBS reception status information sent by a terminal device.

Alternatively, or additionally, the transceiving module 701 is further configured to transmit MBS data that is determined based on the MBS reception status information to the terminal device.

Alternatively, or additionally, the transceiving module 701 is further configured to send indication information to the terminal device. The indication information indicates whether the MBS reception status information is allowed to be reported.

Alternatively, or additionally, the transceiving module 701 is further configured to send the indication information to the terminal device via broadcast signaling or dedicated signaling.

Alternatively, or additionally, the indication information includes at least one of the following:
whether the MBS reception status information is allowed to be reported;
whether frequency information for an MBS reception is allowed to be reported;
whether time domain information for the MBS reception is allowed to be reported;
whether a frequency configuration chosen by the terminal device is allowed to be reported; or
whether a time domain configuration chosen by the terminal device is allowed to be reported.

Alternatively, or additionally, the MBS reception status information includes at least one of the following:
frequency information for the MBS reception;
time domain information for the MBS reception;
configuration information for the MBS reception;
a frequency configuration chosen by the terminal device;
a time domain configuration chosen by the terminal device;
a configuration chosen by the terminal device;
a type of the MBS reception status information;
a wireless technology type of the MBS reception; or
a service type corresponding to the MBS reception.

Alternatively, or additionally, the type of the MBS reception status information includes any one of the following:
a reception status for MBS data being received by the terminal device; or
a reception status for MBS data to be received by the terminal device.

Alternatively, or additionally, the frequency information for the MBS reception or the frequency configuration chosen by the terminal device includes at least one of the following: frequency point information for the MBS reception, bandwidth information for the MBS reception, subcarrier spacing information for the MBS reception, BWP information for the MBS reception, or a resource indication for the MBS reception.

Alternatively, or additionally, the frequency point information for the MBS reception includes at least one of the following: a starting frequency point of the MBS reception, an ending frequency point of the MBS reception, or a central frequency point of the MBS reception.

The bandwidth information for the MBS reception includes at least one of the following: a frequency band width for the MBS reception, or a number of physical resource blocks for the MBS reception.

Alternatively, or additionally, the time domain information for the MBS reception or the time domain configuration chosen by the terminal device includes at least one of the following:
starting time information for the MBS reception, a time period of the MBS reception, a duration of a transmission period within the time period, time domain positions in time in the transmission period, or a number of received symbols.

Alternatively, or additionally, the configuration information for the MBS reception or the configuration chosen by the terminal device includes at least one of the following:
a modulation and demodulation mode used by the terminal device, a maximum number of MIMO antenna layers supported by the terminal device, a number of antennas used for the MBS reception, a number of antenna ports used for the MBS reception, one or more antenna port numbers used for the MBS reception, a number of HARQ processes used, one or more HARQ process numbers used, a repetition transmission scheme of a data channel for an MBS transmission, a cache size used for the terminal device, or a processing capability scaling factor of the terminal device.

Alternatively, or additionally, one or more antennas corresponding to the number of antenna layers, the number of antennas used, the number of antenna ports used and the one or more antenna port numbers used include one or more receiving antennas and/or one or more transmitting antennas.

Alternatively, or additionally, the frequency information for the MBS reception belongs to a same band combination; and/or,
the frequency information for the MBS reception and one or more serving frequency points currently configured for the terminal device belong to the same band combination.

Alternatively, or additionally, the frequency information for the MBS reception does not belong to at least one of the following frequency points:
one or more serving frequency points currently configured for the terminal device;
one or more adjacent frequency points indicated in system information currently received by the terminal device; or
one or more frequency points of a network to which the terminal device is currently registered.

Alternatively, or additionally, the transceiving module 701 is further configured to receive a first indication sent by the terminal device. The first indication indicates frequency information that is applicable to the time domain information for the MBS reception and/or the time domain configuration chosen by the terminal device.

Alternatively, or additionally, the transceiving module 701 is further configured to receive a second indication sent by the terminal device. The second indication indicates one or more channel types that are applicable to the time domain information for the MBS reception. The one or more channel types include at least one of the following types:
a physical control channel for sending broadcast control signaling;
a physical data channel for sending broadcast control signaling;
a physical control channel for transmitting broadcast data; or
a physical data channel for transmitting broadcast data.

In the example of the present disclosure, by receiving the MBS reception status information reported by the terminal device, a current MBS reception status of the terminal device can be identified based on the MBS reception status information. Furthermore, the MBS data is scheduled for the terminal device based on the MBS reception status information. During a scheduling process, suitable MBS data can be scheduled for the terminal device since the network device takes the MBS reception status information into consideration, which can prevent the scheduled MBS data from exceeding the maximum receiving capacity of the terminal device, thereby ensuring the correct transmission of the MBS data and reducing the packet loss rate of the MBS data.

Referring to FIG. 8, it is a schematic structural diagram of another communication apparatus 80 provided in an example of the present disclosure. The communication apparatus 80 may be a network device, may be a terminal device, may be a chip, a chip system or a processor that supports the network device to implement the above methods, or may be a chip, a chip system or a processor that supports the terminal device to implement the above methods. The apparatus may be configured to implement the methods described in the foregoing method examples, whose details may refer to the descriptions in the foregoing method examples.

The communications apparatus 80 may include one or more processors 801. The processor 801 may be a general processor, a dedicated processor or the like. For example, it may be a baseband processor or a central processor. The baseband processor may be configured to process communication protocols and communication data, and the central processor may be configured to control a communication apparatus (such as a base station, a baseband chip, a terminal device, a terminal device chip, a DU or a CU, etc.) to execute a computer program and process data of the computer program.

Alternatively, or additionally, the communication apparatus 80 may further include one or more memories 802, on which a computer program 803 may be stored, and the one or more processors 801 execute the computer program 803, so as to enable the communication apparatus 80 to perform the methods described in the foregoing method examples. Alternatively, or additionally, the one or more memories 802 may further store data. The communication apparatus 80 and the one or more memories 802 may be set separately or integrated together.

Alternatively, or additionally, the communication apparatus 80 may further include one or more transceivers 804 and one or more antennas 805. The transceiver 804 may be referred to as a transceiving unit, a transceiving machine, or a transceiving circuit, etc., and is configured to implement a transmission and reception function. The transceiver 804 may include a receiver and a transmitter. The receiver may be called a receiving machine or a receiving circuit for implementing a reception function, and the transmitter may be called a transmitting machine or a transmitting circuit for implementing a transmission function.

Alternatively, or additionally, the communication apparatus 80 may further include one or more interface circuits 806. The one or more interface circuits 806 are configured to receive and transmit code instructions to the one or more processors 801. The one or more processors 801 execute the code instructions to enable the communication apparatus 80 to perform the methods described in the foregoing method examples.

The communication apparatus 80 is the terminal device configured to implement the functions of the terminal device in the above examples.

The communication apparatus 80 is the network device configured to implement the functions of the network device in the above examples.

In an implementation, the one or more processors 801 may include the one or more transceivers for implementing the transmission and reception function. For example, the transceiver may be a transceiving circuit, or an interface, or an interface circuit. The transceiving circuit, interface or interface circuit for implementing the transmission and reception function may be separated or integrated together. The above transceiver circuit, interface or interface circuit may be configured to read and write code/data. Alternatively, the above transceiver circuit, interface or interface circuit may be configured to transmit or transfer signals.

In an implementation, the one or more processors 801 may store the computer program 803, and the computer program 803 runs on the one or more processors 801 to enable the communication apparatus 80 to perform the methods described in the foregoing method examples. The computer program 803 may be solidified in the one or more processors 801. In this case, the one or more processors 801 may be implemented by hardware.

In an implementation, the communication apparatus 80 may include a circuit, and the circuit may implement the function of transmitting, receiving or communicating in the foregoing method examples. The one or more processors and transceivers described in the present disclosure may be implemented on an integrated circuit (IC), an analog IC, a radio frequency integrated circuit (RFIC), a mixed-signal IC, an application specific integrated circuit (ASIC), a printed circuit board (PCB), an electronic device, etc. The one or more processors and transceivers may also be fabricated with various IC processing technologies such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon germanium (SiGe), gallium arsenide (GaAs), etc.

The communication apparatus described in the above examples may be the network device or a terminal device. However, the communication apparatus described in the present disclosure is not limited by such a range, and the structure of the communication apparatus may not be limited to FIG. 8. The communication apparatus may be a stand-alone device or may be a part of a larger device. For example, the communication apparatus may be:
(1) stand-alone ICs, chips, or chip systems or subsystems;
(2) a set of one or more ICs, which may alternatively or additionally include one or more storage components for storing data and computer programs;
(3) ASIC, such as a modem;
(4) modules that may be embedded in other devices;
(5) a receiver, a terminal device, an intelligent terminal device, a cellular phone, a wireless device, a handset, a mobile unit, a vehicle-mounted device, a network device, a cloud device, an artificial intelligence device, etc.;
(6) others and so on.

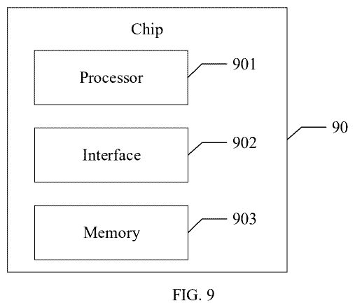

For the case where the communications apparatus may be a chip or a chip system, it may refer to the schematic structural diagram of a chip 90 illustrated in FIG. 9. The chip 90 illustrated in FIG. 9 includes one or more processors 901, one or more interfaces 902 and one or more memories 903. The number of the one or more processors 901 may be one or more than one, and the number of the one or more interfaces 902 may be more than one.

For the case where the chip is configured to implement the functions of a terminal device in the examples of the present disclosure:
the one or more interfaces 902 are configured to send MBS reception status information to a network device.

Alternatively, or additionally, the one or more interfaces 902 are further configured to receive MBS data that is transmitted by the network device based on the MBS reception status information.

Alternatively, or additionally, the one or more interfaces 902 are further configured to receive indication information sent by the network device. The indication information indicates whether the MBS reception status information is allowed to be reported.

Alternatively, or additionally, the one or more interfaces 902 are further configured to receive the indication information sent by the network device via broadcast signaling or dedicated signaling.

Alternatively, or additionally, the indication information includes at least one of the following:
whether the MBS reception status information is allowed to be reported;
whether frequency information for an MBS reception is allowed to be reported;
whether time domain information for the MBS reception is allowed to be reported;
whether a frequency configuration chosen by the terminal device is allowed to be reported; or
whether a time domain configuration chosen by the terminal device is allowed to be reported.

Alternatively, or additionally, the MBS reception status information includes at least one of the following:
frequency information for the MBS reception;
time domain information for the MBS reception;
configuration information for the MBS reception;
a frequency configuration chosen by the terminal device;
a time domain configuration chosen by the terminal device;
a configuration chosen by the terminal device;
a type of the MBS reception status information;
a wireless technology type of the MBS reception; or
a service type corresponding to the MBS reception.

Alternatively, or additionally, the type of the MBS reception status information includes any one of the following:
a reception status for MBS data being received by the terminal device; or
a reception status for MBS data to be received by the terminal device.

Alternatively, or additionally, the frequency information for the MBS reception or the frequency configuration chosen by the terminal device includes at least one of the following: frequency point information for the MBS reception, bandwidth information for the MBS reception, subcarrier spacing information for the MBS reception, BWP information for the MBS reception, or a resource indication for the MBS reception.

Alternatively, or additionally, the frequency point information for the MBS reception includes at least one of the following: a starting frequency point of the MBS reception, an ending frequency point of the MBS reception, or a central frequency point of the MBS reception.

The bandwidth information for the MBS reception includes at least one of the following: a frequency band width for the MBS reception, or a number of physical resource blocks for the MBS reception.

Alternatively, or additionally, the time domain information for the MBS reception or the time domain configuration chosen by the terminal device includes at least one of the following:
starting time information for the MBS reception, a time period of the MBS reception, a duration of a transmission period within the time period, time domain positions in time in the transmission period, or a number of received symbols.

Alternatively, or additionally, the configuration information for the MBS reception or the configuration chosen by the terminal device includes at least one of the following:
a modulation and demodulation mode used by the terminal device, a maximum number of MIMO antenna layers supported by the terminal device, a number of antennas used for the MBS reception, a number of antenna ports used for the MBS reception, one or more antenna port numbers used for the MBS reception, a number of HARQ processes used, one or more HARQ process numbers used, a repetition transmission scheme of a data channel for an MBS transmission, a cache size used for the terminal device, or a processing capability scaling factor of the terminal device.

Alternatively, or additionally, one or more antennas corresponding to the number of antenna layers, the number of antennas used, the number of antenna ports used and the one or more antenna port numbers used include one or more receiving antennas and/or one or more transmitting antennas.

Alternatively, or additionally, the frequency information for the MBS reception belongs to a same band combination; and/or,
the frequency information for the MBS reception and one or more serving frequency points currently configured for the terminal device belong to the same band combination.

Alternatively, or additionally, the frequency information for the MBS reception does not belong to at least one of the following frequency points:
one or more serving frequency points currently configured for the terminal device;
one or more adjacent frequency points indicated in system information currently received by the terminal device; or
one or more frequency points of a network to which the terminal device is currently registered.

Alternatively, or additionally, the one or more interfaces 902 are further configured to indicate frequency information that is applicable to the time domain information for the MBS reception, and/or, to indicate frequency information that is applicable to the time domain configuration chosen by the terminal device.

Alternatively, or additionally, the one or more interfaces 902 are further configured to indicate one or more channel types that are applicable to the time domain information for the MBS reception. The one or more channel types include at least one of the following:
a physical control channel for sending broadcast control signaling;
a physical data channel for sending broadcast control signaling;
a physical control channel for transmitting broadcast data; or
a physical data channel for transmitting broadcast data.

For the case where the chip is configured to implement the functions of a network device in the examples of the present disclosure:
the one or more interfaces 902 are configured to receive MBS reception status information sent by a terminal device.

Alternatively, or additionally, the one or more interfaces 902 are further configured to transmit MBS data that is determined based on the MBS reception status information to the terminal device.

Alternatively, or additionally, the one or more interfaces 902 are further configured to send indication information to the terminal device. The indication information indicates whether the MBS reception status information is allowed to be reported.

Alternatively, or additionally, the one or more interfaces 902 are further configured to send the indication information to the terminal device via broadcast signaling or dedicated signaling.

Alternatively, or additionally, the indication information includes at least one of the following:
whether the MBS reception status information is allowed to be reported;
whether frequency information for an MBS reception is allowed to be reported;
whether time domain information for the MBS reception is allowed to be reported;
whether a frequency configuration chosen by the terminal device is allowed to be reported; or
whether a time domain configuration chosen by the terminal device is allowed to be reported.

Alternatively, or additionally, the MBS reception status information includes at least one of the following:
frequency information for the MBS reception;
time domain information for the MBS reception;
configuration information for the MBS reception;
a frequency configuration chosen by the terminal device;
a time domain configuration chosen by the terminal device;
a configuration chosen by the terminal device;
a type of the MBS reception status information;
a wireless technology type of the MBS reception; or
a service type corresponding to the MBS reception.

Alternatively, or additionally, the type of the MBS reception status information includes any one of the following:
a reception status for MBS data being received by the terminal device; or
a reception status for MBS data to be received by the terminal device.

Alternatively, or additionally, the frequency information for the MBS reception or the frequency configuration chosen by the terminal device includes at least one of the following: frequency point information for the MBS reception, bandwidth information for the MBS reception, subcarrier spacing information for the MBS reception, BWP information for the MBS reception, or a resource indication for the MBS reception.

Alternatively, or additionally, the frequency point information for the MBS reception includes at least one of the following: a starting frequency point of the MBS reception, an ending frequency point of the MBS reception, or a central frequency point of the MBS reception.

The bandwidth information for the MBS reception includes at least one of the following: a frequency band width for the MBS reception, or a number of physical resource blocks for the MBS reception.

Alternatively, or additionally, the time domain information for the MBS reception or the time domain configuration chosen by the terminal device includes at least one of the following:
starting time information for the MBS reception, a time period of the MBS reception, a duration of a transmission period within the time period, time domain positions in time in the transmission period, or a number of received symbols.

Alternatively, or additionally, the configuration information for the MBS reception or the configuration of the terminal device includes at least one of the following:
a modulation and demodulation mode used by the terminal device, a maximum number of MIMO antenna layers supported by the terminal device, a number of antennas used for the MBS reception, a number of antenna ports used for the MBS reception, one or more antenna port numbers used for the MBS reception, a number of HARQ processes used, one or more HARQ process numbers used, a repetition transmission scheme of a data channel for an MBS transmission, a cache size used for the terminal device, or a processing capability scaling factor of the terminal device.

Alternatively, or additionally, one or more antennas corresponding to the number of antenna layers, the number of antennas used, the number of antenna ports used and the one or more antenna port numbers used include one or more receiving antennas and/or one or more transmitting antennas.

Alternatively, or additionally, the frequency information for the MBS reception belongs to a same band combination; and/or,
the frequency information for the MBS reception and one or more serving frequency points currently configured for the terminal device belong to the same band combination.

Alternatively, or additionally, the frequency information for the MBS reception does not belong to at least one of the following frequency points:
one or more serving frequency points currently configured for the terminal device;
one or more adjacent frequency points indicated in system information currently received by the terminal device; or
one or more frequency points of a network to which the terminal device is currently registered.

Alternatively, or additionally, the one or more interfaces 902 are further configured to receive a first indication sent by the terminal device. The first indication indicates frequency information that is applicable to the time domain information for the MBS reception and/or the time domain configuration chosen by the terminal device.

Alternatively, or additionally, the one or more interfaces 902 are further configured to receive a second indication sent by the terminal device. The second indication indicates one or more channel types that are applicable to the time domain information for the MBS reception. The one or more channel types include at least one of the following types:
a physical control channel for sending broadcast control signaling;
a physical data channel for sending broadcast control signaling;
a physical control channel for transmitting broadcast data; or
a physical data channel for transmitting broadcast data.

In the example of the present disclosure, by receiving the MBS reception status information reported by the terminal device, a current MBS reception status of the terminal device can be identified based on the MBS reception status information. Furthermore, the MBS data is scheduled for the terminal device based on the MBS reception status information. During a scheduling process, suitable MBS data can be scheduled for the terminal device since the network device takes the MBS reception status information into consideration, which can prevent the scheduled MBS data from exceeding the maximum receiving capacity of the terminal device, thereby ensuring that the correct transmission of the MBS data and reducing the packet loss rate of the MBS data.

Those skilled in the art may also understand that various illustrative logical blocks and steps presented in the examples of the present disclosure may be implemented through electronic hardware, computer software, or a combination of the both. Whether such functions are implemented through the hardware or the software depends on specific applications and overall system design requirements. Those skilled in the art may use various approaches to implement the described function for each specific application. However, such implementation should not be understood as exceeding the protection scope of the examples of the present disclosure.

An example of the present disclosure also provides a system for sending/receiving MBS reception status information. The system includes the communication apparatus as the terminal device and the communication apparatus as the network device in the example of FIG. 8, or the system includes the communication apparatus as the terminal device and the communication apparatus as the network device in the example of FIG. 9.

The present disclosure also provides a readable storage medium on which instructions are stored. The instructions, when executed by a computer, implement the functions of any one of the foregoing method examples.

The present disclosure also provides a computer program product, which implements the functions of any one of the foregoing method examples when being executed by a computer.

In the above examples, it can be implemented in whole or in part by software, hardware, firmware, or any combination thereof. When implemented in software, it may be implemented in whole or in part in the form of a computer program product. The computer program product includes one or more computer programs. When the computer programs are loaded and executed on a computer, the processes or function according to the examples of the present disclosure are generated in whole or in part. The computer may be a general-purpose computer, a dedicated computer, a computer network, or another programmable device. The computer programs may be stored in a computer-readable storage medium or transmitted from one computer-readable storage medium to another computer-readable storage medium, for example, the computer programs may be transmitted from a website site, a computer, a server or a data center via wire (for example, coaxial cable, optical fiber, digital subscriber line (DSL)) or wireless (for example, infrared, wireless, microwave, etc.) to another website site, another computer, another server, or another data center. The computer-readable storage medium may be any available medium that can be accessed by a computer or a data storage device such as a server and a data center integrating one or more available media. The available medium may be a magnetic medium (for example, a floppy disk, a hard disk, a magnetic tape), an optical medium (for example, a high-density digital video disc (DVD)), or a semiconductor medium (for example, a solid state disk (SSD)), etc.

Those of ordinary skill in the art may understand that the division of the first, second, and other numbers involved in the present disclosure are only for convenience of description, instead of limiting the scope of the examples of the present disclosure or indicating a sequential order.

“At least one” in the present disclosure may also be described as “one or more”. The “more” may refer to two, three, four or more, which is not limited in the present disclosure. In the examples of the present disclosure, for a technical character, its technical features are distinguished by “first,” “second,” “third,” “A,” “B,” “C,” and “D,” etc. There is no sequential order or size order between the technical features described by the “first,” “second,” “third,” “A,” “B,” “C,” and “D.”

The corresponding relationships shown in each table in the present disclosure may be configured or predefined. The values of the information in each table are only examples and may be configured to other values, which is not limited in the present disclosure. When configuring the corresponding relationships between information and parameters, it is not necessarily required to configure all the corresponding relationship shown in each table. As an example, in the tables of the present disclosure, the corresponding relationships shown in some rows may not be configured. As another example, appropriate deformation adjustments may be made based on the table, e.g., splitting, merging, etc. The name of the parameter shown in the title of each table may also be presented under other names understandable to the communication apparatus, and the values or representations of its parameters may also be presented under other values or representations understandable to the communication apparatus. When implementing the various tables, other data structures may also be used, such as arrays, queues, containers, stacks, linear lists, pointers, linked lists, trees, graphs, structures, classes, heaps, or hash tables.

Being predefined in the present disclosure may be understood as being defined, being predefined, being stored, being pre-stored, being pre-negotiated, being pre-configured, being solidified, or being pre-burned.

Those skilled in the art may appreciate that the units and algorithm steps of each example described in conjunction with the example disclosed herein may be implemented by electronic hardware, computer software, or a combination of computer software and electronic hardware. Whether a certain function is performed in a hardware or software way depends on a specific application and design constraint conditions of the technical solution. Those skilled in the art may adopt different methods for each specific application to implement the described functions, which, however, should not be considered as being beyond the scope of the present disclosure.

Those skilled in the art may clearly understand that, for the convenience and brevity of description, the specific working processes of the systems, apparatuses, and units described above may refer to the corresponding processes in the foregoing method examples and will not be repeated here.

The foregoing description is merely specific implementations of the present disclosure, but the protection scope of the present disclosure is not limited thereto, and any variation or replacement within the technical scope disclosed in the present disclosure, which is readily conceivable by a person skilled in the art, should belong to the protection scope of the present disclosure. Therefore, the protection scope of the present disclosure should be based on the protection scope of the claims.

1. A method for sending multicast broadcast service (MBS) reception status information, performed by a terminal device, comprising:
sending MBS reception status information to a network device.

2. The method according to claim 1, further comprising at least one of:
receiving MBS data that is transmitted by the network device based on the MBS reception status information, or
receiving indication information sent by the network device, wherein the indication information indicates whether the MBS reception status information is allowed to be reported, and wherein the indication information is sent by the network device via broadcast signaling or dedicated signaling.

3.-4. (canceled)

5. The method according to claim 2, wherein the indication information comprises at least one of:
whether the MBS reception status information is allowed to be reported;
whether frequency information for an MBS reception is allowed to be reported;
whether time domain information for the MBS reception is allowed to be reported;
whether a frequency configuration chosen by the terminal device is allowed to be reported; or
whether a time domain configuration chosen by the terminal device is allowed to be reported.

6. The method according to claim 1, wherein the MBS reception status information comprises at least one of:
frequency information for an MBS reception;
time domain information for the MBS reception;
configuration information for the MBS reception;
a frequency configuration chosen by the terminal device;
a time domain configuration chosen by the terminal device;
a configuration chosen by the terminal device;
a type of the MBS reception status information;
a wireless technology type of the MBS reception; or
a service type corresponding to the MBS reception.

7. The method according to claim 6,
wherein the type of the MBS reception status information comprises any one of:
a reception status for MBS data being received by the terminal device; or
a reception status for MBS data to be received by the terminal device; or
wherein the frequency information for the MBS reception or the frequency configuration chosen by the terminal device comprises at least one of:
frequency point information for the MBS reception;
bandwidth information for the MBS reception;
subcarrier spacing information for the MBS reception;
bandwidth part (BWP) information for the MBS reception; or
a resource indication for the MBS reception; or
wherein the time domain information for the MBS reception or the time domain configuration chosen by the terminal device comprises at least one of:
starting time information for the MBS reception;
a time period of the MBS reception;
a duration of a transmission period within the time period;
time domain positions in time in the transmission period or a number of received symbols; or
wherein the configuration information for the MBS reception or the configuration chosen by the terminal device comprises at least one of:
a modulation and demodulation mode used by the terminal device,
a maximum number of multiple-input multiple-output (MIMO) antenna layers supported by the terminal device,
a number of antennas used for the MBS reception,
a number of antenna ports used for the MBS reception,
one or more antenna port numbers used for the MBS reception,
a number of hybrid automatic repeat request (HARQ) processes used,
one or more HARQ process numbers used,
a repetition transmission scheme of a data channel for an MBS transmission,
a cache size used for the terminal device, or
a processing capability scaling factor of the terminal device.

8. (canceled)

9. The method according to claim 7,
wherein the frequency point information for the MBS reception comprises at least one of:
a starting frequency point of the MBS reception,
an ending frequency point of the MBS reception, or
a central frequency point of the MBS reception; and
wherein the bandwidth information for the MBS reception comprises at least one of:
a frequency band width for the MBS reception, or
a number of physical resource blocks for the MBS reception.

10.-11. (canceled)

12. The method according to claim 7, wherein one or more antennas corresponding to the number of antenna layers, the number of antennas used, the number of antenna ports used and the one or more antenna port numbers used comprise one or more receiving antennas, one or more transmitting antennas, or a combination thereof.

13. The method according to claim 6, wherein the frequency information for the MBS reception meets at least one of:
a case that the frequency information for the MBS reception belongs to a same band combination;
a case that the frequency information for the MBS reception and one or more serving frequency points currently configured for the terminal device belong to the same band combination; or
a case that the frequency information for the MBS reception does not belong to at least one of:
one or more serving frequency points currently configured for the terminal device;
one or more adjacent frequency points indicated in system information currently received by the terminal device; or
one or more frequency points of a network to which the terminal device is currently registered.

14. (canceled)

15. The method according to claim 6, further comprising at least one of:
indicating frequency information that is applicable to at least one of the time domain information for the MBS reception; or
the time domain configuration chosen by the terminal device; or
indicating one or more channel types that are applicable to the time domain information for the MBS reception, wherein the one or more channel types comprise at least one of:
a physical control channel for sending broadcast control signaling;
a physical data channel for sending broadcast control signaling;
a physical control channel for transmitting broadcast data; or
a physical data channel for transmitting broadcast data.

16. (canceled)

17. A method for receiving multicast broadcast service (MBS) reception status information, performed by a network device, comprising:
receiving MBS reception status information sent by a terminal device.

18. The method according to claim 17, further comprising at least one of:
transmitting MBS data that is determined based on the MBS reception status information to the terminal device; or
sending indication information to the terminal device, wherein the indication information indicates whether the MBS reception status information is allowed to be reported, and wherein the indication information is sent to the terminal device via broadcast signaling or dedicated signaling.

19.-20. (canceled)

21. The method according to claim 18, wherein the indication information comprises at least one of:
whether the MBS reception status information is allowed to be reported;
whether frequency information for an MBS reception is allowed to be reported;
whether time domain information for the MBS reception is allowed to be reported;
whether a frequency configuration chosen by the terminal device is allowed to be reported; or
whether a time domain configuration chosen by the terminal device is allowed to be reported.

22. The method according to claim 17, wherein the MBS reception status information comprises at least one of:
frequency information for an MBS reception;
time domain information for the MBS reception;
configuration information for the MBS reception;
a frequency configuration chosen by the terminal device;
a time domain configuration chosen by the terminal device;
a configuration chosen by the terminal device;
a type of the MBS reception status information;
a wireless technology type of the MBS reception; or
a service type corresponding to the MBS reception.

23. The method according to claim 22,
wherein the type of the MBS reception status information comprises any one of:
a reception status for MBS data being received by the terminal device; or
a reception status for MBS data to be received by the terminal device; or
wherein the frequency information for the MBS reception or the frequency configuration chosen by the terminal device comprises at least one of:
frequency point information for the MBS reception,
bandwidth information for the MBS reception,
subcarrier spacing information for the MBS reception,
bandwidth part (BWP) information for the MBS reception, or
a resource indication for the MBS reception; or
wherein the time domain information for the MBS reception or the time domain configuration chosen by the terminal device comprises at least one of:
starting time information for the MBS reception;
a time period of the MBS reception;
a duration of a transmission period within the time period;
time domain positions in time in the transmission period; or
a number of received symbols; or
wherein the configuration information for the MBS reception or the configuration chosen by the terminal device comprises at least one of:
a modulation and demodulation mode used by the terminal device,
a maximum number of multiple-input multiple-output (MIMO) antenna layers supported by the terminal device.
a number of antennas used for the MBS reception,
a number of antenna ports used for the MBS reception,
one or more antenna port numbers used for the MBS reception.
a number of hybrid automatic repeat request (HARQ) processes used,
one or more HARQ process numbers used,
a repetition transmission scheme of a data channel for an MBS transmission,
a cache size used for the terminal device, or
a processing capability scaling factor of the terminal device.

24. (canceled)

25. The method according to claim 23,
wherein the frequency point information for the MBS reception comprises at least one of:
a starting frequency point of the MBS reception,
an ending frequency point of the MBS reception, or
a central frequency point of the MBS reception; and
wherein the bandwidth information for the MBS reception comprises at least one of:
a frequency band width for the MBS reception, or
a number of physical resource blocks for the MBS reception.

26.-27. (canceled)

28. The method according to claim 23, wherein one or more antennas corresponding to the number of antenna layers, the number of antennas used, the number of antenna ports used and the one or more antenna port numbers used comprise one or more receiving antennas, one or more transmitting antennas, or a combination thereof.

29. The method according to claim 22, wherein the frequency information for the MBS reception meets at least one of:
a case that the frequency information for the MBS reception belongs to a same band combination;
a cast that the frequency information for the MBS reception and one or more serving frequency points currently configured for the terminal device belong to the same band combination; or
a case that the frequency information for the MBS reception does not belong to at least one of:
one or more serving frequency points currently configured for the terminal device;
one or more adjacent frequency points indicated in system information currently received by the terminal device; or
one or more frequency points of a network to which the terminal device is currently registered.

30. (canceled)

31. The method according to claim 22, further comprising at least one of:
receiving a first indication sent by the terminal device, wherein the first indication indicates frequency information that is applicable to at least one of the time domain information for the MBS reception or the time domain configuration chosen by the terminal device.; or
receiving a second indication sent by the terminal device, wherein the second indication indicates one or more channel types that are applicable to the time domain information for the MBS reception, and wherein the one or more channel types comprise at least one of:
a physical control channel for sending broadcast control signaling;
a physical data channel for sending broadcast control signaling;
a physical control channel for transmitting broadcast data; or
a physical data channel for transmitting broadcast data.

32.-34. (canceled)

35. A communication apparatus, comprising:
one or more processors, and
one or more memories that store a computer program,
wherein the computer program when collectively executed by the one or more processors cause the communication apparatus to send MBS reception status information to a network device.

36. A communication apparatus, comprising:
one or more processors, and
one or more memories that store a computer program,
wherein the computer program when collectively executed by the one or more processors cause the communication apparatus to act as the network device and perform the method according to claim 17.

37.-38. (canceled)
